(19) United States
(12) Patent Application Publication
(10) Pub. No.: US 2026/0134480 A1
(43) Pub. Date: May 14, 2026

(54) DECISION SUPPORT SYSTEM INCLUDING SPARSIFIED MACHINE-LEARNED MODEL FOR AUTOMATIC GENERATION OF APPEALS

(71) Applicant: Optum, Inc., Minnetonka, MN (US)

(72) Inventors: Srilekha Akula, Fremont, CA (US); Rishi Yagnik, Irving, TX (US)

(21) Appl. No.: 18/941,211

(22) Filed: Nov. 8, 2024

(51) Int. Cl. G06Q 40/08; G06Q 10/10

(52) U.S. Cl. CPC G06Q 40/08; G06Q 10/10

(57) ABSTRACT

A computer-implemented method includes receiving, by one or more processors, a denial notification for a health care claim associated with a patient; generating, by the one or more processors, an appeal support data set, the appeal support data set comprising clinical data associated with the patient and administrative data associated with the patient, the appeal support data set being a sparsified subset of a larger appeal support data set and having a reduced dimensionality relative to the larger appeal support data set; applying, by the one or more processors and to the appeal support data set and the health care claim, a machine-learned prediction model that is trained to generate an appeal success prediction score; generating, by the one or more processors, an appeal of the denial notification in a format compatible with a standard defined by a payor that issued the denial notification when the appeal success prediction score satisfies an appeal success threshold; and transmitting, by the one or more processors, the appeal to the payor that issued the denial notification using a communication protocol compatible with a system used by the payor in processing the appeal.

### FIELD OF INVENTION

The present disclosure relates generally to decision support systems and services.

### BACKGROUND

Health care service providers have patients that pay for their care using a variety of different payors. For example, a medical facility or practice may serve patients that pay by way of different insurance companies including, but not limited to, private insurance plans, government insurance plans, such as Medicare, Medicaid, and state or federal public employee insurance plans, and/or hybrid insurance plans, such as those that are sold through the Affordable Care Act. When providers submit claims to the payors for payment, the claims can be denied in whole or in part for a variety of different reasons. Providers or patients then have the option of appealing the payment denial for reconsideration by the payor. Reviewing the denial reasons and the original claim, generating a revised claim and/or providing supporting documentation or reasons for approval of the claim can be a time consuming and labor-intensive process. In some instances, valid claims or claims that can be made valid are written off instead of appealing as the cost of the appeal does not justify the return.

### SUMMARY

According to some embodiments of the disclosure, a computer-implemented method comprises: receiving, by one or more processors, a denial notification for a health care claim associated with a patient; generating, by the one or more processors, an appeal support data set, the appeal support data set comprising clinical data associated with the patient and administrative data associated with the patient, the appeal support data set being a sparsified subset of a larger appeal support data set and having a reduced dimensionality relative to the larger appeal support data set; applying, by the one or more processors and to the appeal support data set and the health care claim, a machine-learned prediction model that is trained to generate an appeal success prediction score; generating, by the one or more processors, an appeal of the denial notification in a format compatible with a standard defined by a payor that issued the denial notification when the appeal success prediction score satisfies an appeal success threshold; and transmitting, by the one or more processors, the appeal to the payor that issued the denial notification using a communication protocol compatible with a system used by the payor in processing the appeal.

In other embodiments, the computer-implemented method further comprises: training the machine-learned prediction model using historical health care claims associated with historical patients, each of the historical health care claims including historical clinical data and historical administrative data corresponding to a respective historical patient, and using historical claim adjudication results from the payor; wherein the historical clinical data includes one or more procedure codes respectively associated with one or more health care procedures performed on the respective historical patient; and wherein the historical administrative data includes demographic information for the respective historical patient and information on a health care insurance policy associated with the respective historical patient.

In still other embodiments, generating the appeal of the denial notification comprises: applying a language model to the denial notification, the appeal support data set, the health care claim, and a process instruction document to extract appeal content therefrom; and using a generative Artificial Intelligence system to generate the appeal based on the appeal content.

In still other embodiments, the appeal success prediction score is a first appeal success prediction score, the computer-implemented method further comprising: applying, by the one or more processors and to the appeal support data and the health care claim, a payor rule set to generate a second appeal success prediction score, the payor rule set including one or more administrative rules used by the payor in health care claim adjudication.

In still other embodiments, the computer-implemented method further comprises: combining the first appeal success prediction score and the second appeal success prediction score to generate a composite appeal success prediction score; wherein generating the appeal of the denial notification comprises: generating, by the one or more processors, the appeal of the denial notification in the format compatible with the standard defined by the payor that issued the denial notification when the composite appeal success prediction score satisfies a composite appeal success threshold.

In still other embodiments, the payor rule set comprises a common rule set that is applicable to multiple payors and a specific rule set that is unique to the payor.

In still other embodiments, the computer-implemented method further comprises: applying, by the one or more processors and to the appeal support data and the health care claim, the payor rule set and payor responses to determine whether additional clinical or administrative information is needed to adjudicate the claim; retrieving, by the one or more processors, the additional clinical or administrative information responsive to determining that the additional clinical or administrative information is needed to adjudicate the claim; and supplementing the health care claim with the additional clinical or administrative information; wherein the appeal includes the health care claim supplemented with the additional clinical or administrative information.

In still other embodiments, the additional clinical or administrative information is electronically stored in a networked public health information exchange storage area or a networked proprietary health information storage area, which are accessible by one or more entities in addition to a provider of health care services to the patient.

In still other embodiments, retrieving the additional clinical or administrative information comprises: applying, by the one or more processors, one or more of a plurality of retrieval techniques to electronically retrieve the additional clinical or administrative information.

In still other embodiments, the plurality of retrieval techniques comprises an automated data pull technique. a request-response technique, a Fast Healthcare Interoperability Resources (FHIR) protocol, sending a request to the provider to return the additional clinical or administrative information in an Electronic Data Interchange (EDI) format, and sending an electronic mail message to the provider requesting the additional clinical or administrative information.

In still other embodiments, the computer-implemented method further comprises: receiving, by the one or more processors, user input authorizing an appeal when the appeal success prediction score does not satisfy the appeal success threshold; wherein generating the appeal of the denial notification comprises: generating, by the one or more processors, the appeal of the denial notification in the format compatible with the standard defined by the payor that issued the denial notification responsive to the user input authorizing the appeal.

In still other embodiments, the clinical data includes one or more procedure codes respectively associated with one or more health care procedures performed on the patient; and the administrative data includes demographic information for the patient and information on a health care insurance policy associated with the patient.

According to some embodiments of the disclosure, a system comprises one or more processors; and one or more memories storing process-executable instructions that, when executed by the one or more processors, cause the one or more processors to perform operations comprising: receiving a denial notification for a health care claim associated with a patient; generating an appeal support data set, the appeal support data set comprising clinical data associated with the patient and administrative data associated with the patient, the appeal support data set being a sparsified subset of a larger appeal support data set and having a reduced dimensionality relative to the larger appeal support data set; applying to the appeal support data set and the health care claim a machine-learned prediction model that is trained to generate an appeal success prediction score; generating an appeal of the denial notification in a format compatible with a standard defined by a payor that issued the denial notification when the appeal success prediction score satisfies an appeal success threshold; and transmitting the appeal to the payor that issued the denial notification using a communication protocol compatible with a system used by the payor in processing the appeal.

In further embodiments, the appeal success prediction score is a first appeal success prediction score, the operations further comprising: applying to the appeal support data and the health care claim a payor rule set to generate a second appeal success prediction score, the payor rule set including one or more administrative rules used by the payor in health care claim adjudication.

In still further embodiments, the operations further comprise: combining the first appeal success prediction score and the second appeal success prediction score to generate a composite appeal success prediction score; wherein generating the appeal of the denial notification comprises: generating the appeal of the denial notification in the format compatible with the standard defined by the payor that issued the denial notification when the composite appeal success prediction score satisfies a composite appeal success threshold.

In still further embodiments, the operations further comprise: applying to the appeal support data and the health care claim the payor rule set and payor responses to determine whether additional clinical or administrative information is needed to adjudicate the claim; retrieving the additional clinical or administrative information responsive to determining that the additional clinical or administrative information is needed to adjudicate the claim; and supplementing the health care claim with the additional clinical or administrative information; wherein the appeal includes the health care claim supplemented with the additional clinical or administrative information.

In still further embodiments, the additional clinical or administrative information is electronically stored in a networked public health information exchange storage area or a networked proprietary health information storage area, which are accessible by one or more entities in addition to a provider of health care services to the patient.

In still further embodiments, retrieving the additional clinical or administrative information comprises: applying one or more of a plurality of retrieval techniques to electronically retrieve the additional clinical or administrative information.

In still further embodiments, the operations further comprise: receiving user input authorizing an appeal when the appeal success prediction score does not satisfy the appeal success threshold; wherein generating the appeal of the denial notification comprises: generating the appeal of the denial notification in the format compatible with the standard defined by the payor that issued the denial notification responsive to the user input authorizing the appeal.

According to some embodiments of the disclosure, one or more non-transitory computer-readable media storing processor-executable instructions that, when executed by one or more processors, cause the one or more processors to perform operations comprising: receiving a denial notification for a health care claim associated with a patient; generating an appeal support data set, the appeal support data set comprising clinical data associated with the patient and administrative data associated with the patient, the appeal support data set being a sparsified subset of a larger appeal support data set and having a reduced dimensionality relative to the larger appeal support data set; applying to the appeal support data set and the health care claim, a machine-learned prediction model that is trained to generate an appeal success prediction score; generating an appeal of the denial notification in a format compatible with a standard defined by a payor that issued the denial notification when the appeal success prediction score satisfies an appeal success threshold; and transmitting the appeal to the payor that issued the denial notification using a communication protocol compatible with a system used by the payor in processing the appeal.

Other methods, systems, articles of manufacture, and/or computer program products according to embodiments of the disclosure will be or become apparent to one with skill in the art upon review of the following drawings and detailed description. It is intended that all such additional systems, methods, articles of manufacture, and/or computer program products be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including an Artificial Intelligence (AI) assisted decision support system for automatic generation of health care claim appeals in accordance with some embodiments of the disclosure;

FIG. 2 is a block diagram that illustrates the AI assisted decision support system for automatically generating health care claim appeals in accordance with some embodiments of the disclosure;

FIG. 3 is a block diagram of an AI based appeal success prediction system in accordance with some embodiments of the disclosure;

FIG. 4 is a block diagram of an appeal data enrichment system in accordance with some embodiments of the disclosure;

FIGS. 5 and 6 are flowcharts that illustrate operations of the AI assisted decision support system for automatically generating health care claim appeals in accordance with some embodiments of the disclosure;

FIG. 7 is a data processing system that may be used to implement an AI assisted decision support system for automatically generating health care claim appeals in accordance with some embodiments of the disclosure; and

FIG. 8 is a block diagram that illustrates a software/hardware architecture for use in an AI assisted decision support system for automatically generating health care claim appeals in accordance with some embodiments of the disclosure.

### DETAILED DESCRIPTION

In the following detailed description, numerous specific details are set forth to provide a thorough understanding of embodiments of the disclosure. However, it will be understood by those skilled in the art that embodiments of the disclosure may be practiced without these specific details. In some instances, well-known methods, procedures, components, and circuits have not been described in detail so as not to obscure the disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term “provider” may mean any person or entity involved in providing health care products and/or services to a patient.

Embodiments of the disclosure are described herein in the context of an Artificial Intelligence (AI) assisted decision support system for automatic generation of health care claim appeals in response to claim denials by payors. It will be understood, however, that embodiments of the disclosure are applicable generally to automatically generating an appeal of a decision by an adjudicative authority. The AI model of the AI assisted decision support system for automatic generation of health care claim appeals may be embodied in a variety of different ways including, but not limited to, one or more of the following AI systems: a multi-layer neural network, a machine learning system, a deep learning system, a large language model, a natural language processing system, and/or computer vision system. Moreover, it will be understood that the multi-layer neural network is a multi-layer artificial neural network comprising artificial neurons or nodes and does not include a biological neural network comprising real biological neurons. The AI models described herein may be configured to transform a memory of a computer system to include one or more data structures, such as, but not limited to, arrays, extensible arrays, linked lists, binary trees, balanced trees, heaps, stacks, and/or queues. These data structures can be configured or modified through the adjudication process and/or the AI training process to improve the efficiency of a computer system when the computer system operates in an inference mode to make an inference, prediction, classification, suggestion, or the like with respect to automatically generating an appeal of a decision by an adjudicative authority.

Health care service providers have patients that pay for their care using a variety of different payors. For example, a medical facility or practice may serve patients that pay by way of different insurance companies including, but not limited to, private insurance plans, government insurance plans, such as Medicare, Medicaid, and state or federal public employee insurance plans, and/or hybrid insurance plans, such as those that are sold through the Affordable Care Act. When providers and/or patients submit claims to the payors for payment, the claims can be denied in whole or in part for a variety of different reasons including, but not limited to, incorrect data in the claim, such as the wrong name for the patient or billing code medical coding errors, medical necessity, cost control, e.g., a less expensive option must be tried first, the service or product is not covered under the insurance plan's terms, the provider is not part of the insurance plan's network, the claim has missing details or attachments, the insurance plan's rules were not followed, e.g., pre-authorization is required, but not obtained. When a provider and/or patient receives notice that a payor has denied payment in whole or in part for a claim, the provider and/or patient may choose to appeal the payor's decision to deny payment, which may include an updated claim with revised and/or supplemental information, and may further include arguments explaining why the provider and/or patient believe the claim was improperly denied.

Upon receiving an appeal of a claim that has been denied in whole or in part, a payor will typically have the appeal entered into an appeal tracking system for tracking the status of the appeal during the reconsideration process. A payor may have a set of guidelines and regulations for processing the appeal, which may be known as Process Instructions (PI). One or more persons tasked with adjudicating the appeal may manually review the appeal documentation, including the claim and claim attachments, along the PI documentation. In addition, the person(s) processing the appeal may reach out to one or more internal and/or external sources for information that may be pertinent to processing the appeal. For example, the provider may be contacted to obtain information from the patient's medical record, an internal eligibility system may be contacted to obtain details on a patient's eligibility and coverage under one or more plans, and/or the Center for Medicare and Medicaid Services (CMS) may be contacted to obtain information on their guidelines. After applying the rules set forth in the PI document to the claim including any supplemental information obtained from internal and/or external sources, the person(s) in charge of adjudicating the appeal may communicate an appeal decision to the provider and/or patient. This largely manual process of generating an appeal of a denied claim and adjudicating the appeal of the denied claim may be time consuming and expensive for the provider, the patient, and/or the payor.

Some embodiments of the disclosure stem from a realization that the use of an intermediary located in the cloud, such as a clearinghouse for processing claims generated by providers, may be configured to determine which claims that have been denied by a payor may have a satisfactorily high probability of being approved by the payor if they are appealed. These claims may then be automatically appealed to the payor, which may alleviate the manual and potentially time consuming and expensive burden of analyzing the denial from the payor along with the claim, determining whether to appeal the denial, and then generating a potentially modified claim and/or additional supporting remarks that support approval of the claim by the payor. Moreover, by increasing the quality of appealed claims, the payor may likewise save time, resources, and expense in adjudicating the appeals as the claims may be more likely to be approved for payment without the need for generating a subsequent denial. For example, an AI assisted decision support system for automatically generating an appeal of a denied claim may, in response to receiving a denial notification of a health care claim, generate an appeal support data set. The appeal support data set includes clinical data associated with the patient along with administrative data associated with the patient. The clinical data may include, for example, one or more procedure codes (e.g., Current Procedural Terminology (CPT) codes) from the patient's clinical record. The administrative data may include demographic information for the patient and/or information on a health care insurance policy associated with the patient. This may include the identification of a particular coverage plan and the characteristics associated therewith, such as deductibles, co-payments, and the like. A machine-learned prediction model that is trained to generate an appeal success prediction score is applied to the appeal support data set and the health care claim. The appeal success prediction score is indicative of a likelihood that the denied claim will be approved if re-submitted in its current or a modified form. The machine-learned prediction model may be trained using historical information on health care claims that have been approved by the payor and the claims that have been denied by the payor. The historical claims used to train the machine-learned prediction model may include historical clinical data and historical administrative data corresponding to historical patients. The training data further includes adjudication results (i.e., denied, denied in part, or approved) from the payor for these historical claims. An appeal of the denial notification of the health care claim is generated in a format compatible with a standard defined by the payor when the appeal success prediction score satisfies an appeal success threshold. The appeal may be automatically transmitted to the payor using a communication protocol that is compatible with a system used by the payor in processing the appeal.

According to some embodiments of the disclosure, the features used during the training of the machine-learned prediction model may be evaluated and one or more of the features with a lesser relative impact on the appeal success prediction score than other features may be removed as part of a model sparsification process during both training and inference model to sparsify the machine-learned prediction model. When the machine-learned prediction model comprises a neural network, one or more nodes or paths may be removed based on the elimination of one or more features. Advantageously, sparsification of the machine-learned model may allow the model to execute using less memory and reduced computational requirements.

Advantageously, one or more of the features used in training or during inference mode of the machine-learned prediction model may be selected to have different quantization levels, e.g., 64-bit, 32-bit, etc. to reduce the size and complexity of the machine-learned model.

In some embodiments, a generative AI system may be used to automatically generate the appeal. The generative AI system may use a large language model that is based on a transformer architecture. Advantageously, the transformer architecture may provide for the ability to process an entire word sequence at once as opposed to one step at a time. This parallelization allows large language models based on a transformer architecture to be faster to train and operate in inference mode thereby improving the performance of a computer system.

The machine-learned prediction model may be supplemented with a rules engine to generate assessment of the likelihood that a denied claim may be successfully appealed. A payor rule set including one or more administrative rules used by the payor in deciding whether to approve a claim for payment may be compiled and applied to the appeal support data and the health care claim to generate a second appeal success prediction score. The first appeal success prediction score generated by the machine-learned prediction model and the second appeal success prediction score generated by the rules engine may be logically and/or mathematically combined to generate a composite appeal success prediction score. When the composite appeal success prediction score satisfies a composite appeal success threshold, the appeal of the denial notification may be automatically generated as described above.

In some circumstances, a health care claim that has been denied may be enriched or supplemented with additional or revised information that would increase the likelihood that the claim would be approved when an appeal is submitted to the payor. For example, the payor rule set and payor responses including the administrative rules described above may be applied to the appeal support data and the health care claim to determine whether additional clinical or administrative information may be needed by the payor to approve the claim for payment. Various factors may be used to make this determination including the presence of one or more procedure codes (e.g., Current Procedural Terminology (CPT) codes) that are indicative of diagnoses, procedures, services, medications, or other forms of health care services or products that may require additional clinical or administrative information from the patient's medical record before a payor can authorize payment. These procedure codes may be indicative of services and/or products that are of questionable medical necessity. Another factor that may be considered is whether the claim includes information of questionable accuracy. The claim enrichment process may involve analyzing the claim for internal consistency and may consider the particular provider that is submitting the claim. For example, some providers may develop a reputation for submitting claims with errant or incorrect information. Thus, claims submitted from certain providers may be identified as requiring additional clinical or administrative information to support the services and/or medications provided that are listed thereon. Yet another factor that may be considered is whether the claim has one or more procedure codes that are inconsistent with a risk adjustment factor associated with the patient. Risk adjustment is a methodology that equates the health status of a patient to a number, called a risk score, to predict healthcare costs. The “risk” to a health plan insurer with expected high healthcare use is “adjusted” by also insuring members with anticipated lower healthcare costs. Risk adjustment is how payors participating in specific programs get payment for managing the healthcare needs of members based on their diagnoses. Thus, if a provider submits a claim for a patient with services and/or products that are inconsistent with the expected healthcare use for that patient based on the patient's risk adjustment factor, then additional clinical or administrative information from the patient's record may be required to support these services and/or products before a payor authorizes payment for the claim.

When a determination is made that additional clinical or administrative information is needed, the additional clinical or administrative information needed to supplement the claim may be automatically retrieved without the need for manual intervention. These retrieval techniques may include, but are not limited to, accessing a storage area to retrieve the additional clinical or administrative information using Fast Healthcare Interoperability Resources (FHIR) protocol, sending a request to the provider to return the additional clinical or administrative information in an Electronic Data Interchange (EDI) format, or sending an electronic mail message to the provider requesting the additional clinical or administrative information. Multiple retrieval techniques may be used to retrieve the additional clinical or administrative information as not all of the clinical information may be accessible via the same retrieval technique. Even in circumstances where all of the information may be accessible via the same retrieval technique, there may be portions of the information that is accessible via a faster retrieval technique so that it may be more efficient to use the faster retrieval technique for retrieving portion of the information while using a slower retrieval technique to retrieve the remainder of the information. Certain retrieval techniques may be prioritized over other retrieval techniques based on speed, reliability, and/or security considerations. The storage area may be implemented in a variety of different ways in accordance with various embodiments of the disclosure. For example, the storage area may be part of one or more clinical networks that may be used to implement a local area, wide area, or national health information exchange, e.g., a publicly accessible networked health information exchange. In other embodiments, a provider may implement its own proprietary network endpoint for housing its own clinical data. The provider may grant other entities direct access to its own electronic health records stored at this end point.

Once additional clinical or administrative information is retrieved by, for example, retrieving a patient's medical record, the additional clinical or administrative information may be communicated along with the claim to the payor as part of the appeal. A patient's medical record may be large and include much information that is not needed by the payor to adjudicate the claim. In some embodiments, a claim may be enriched or supplemented by extracting a portion of the patient's medical record that is relevant to adjudication of the claim.

Embodiments of the disclosure may provide several advantages including, but not limited to, the automatic generation of an appeal of negative decision by an adjudicative authority, such as a denial of a health care claim by a payor, without user input, but while allowing the user to proceed with the appeal should the user with to override the recommendation of the system. Advantageously, a health care claim appeal can be automatically formatted in a manner that conforms to a standard used by a payor's system to process appeals. Furthermore, the appeal can be automatically communicated to the payor using a communication protocol compatible with the system used by the payor in processing appeals. Advantageously, to further enhance the likelihood of the health care claim being approved for payment in response to an appeal, the appeal data may be enriched by supplementing the appeal data with clinical and/or administrative information that the payor may use or require for a successful adjudication of the claim. The additional clinical and/or administrative information may be retrieved from one or more storage locations using a variety of different protocols that facilitate the retrieval of the information. In accordance with different embodiments, the protocols used may be prioritized based on speed, reliability, security, or other factors.

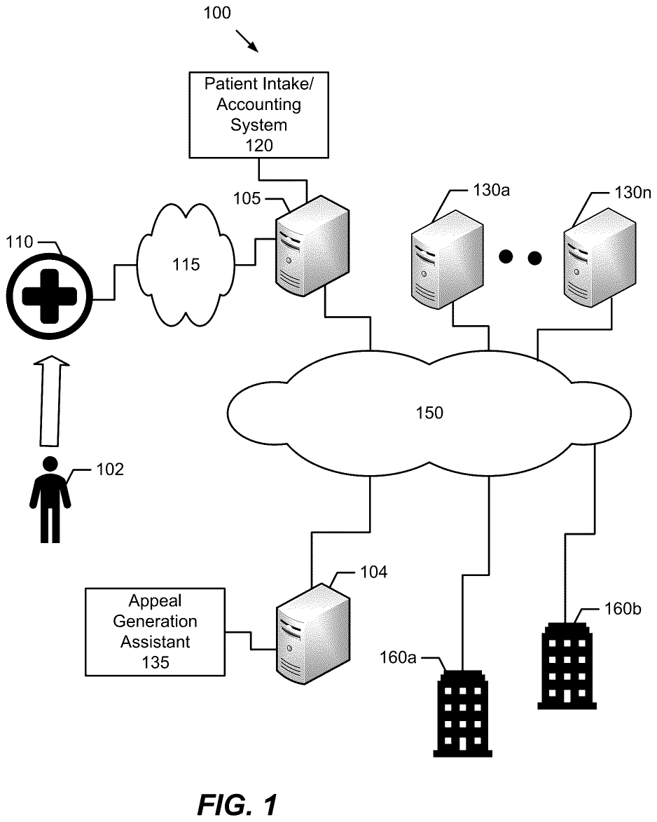

Referring to FIG. 1, a communication network 100 including an AI assisted decision support system for automatically generating an appeal of a decision, such as a denial of a health care claim by a payor, in accordance with some embodiments of the disclosure, comprises one or more health care provider facilities or practices 110 that treats one or more patients 102. Each health care provider facility or practice may represent various types of organizations that are used to deliver health care services to patients via health care professionals, which are referred to generally herein as “providers.” The providers may include, but are not limited to, hospitals, medical practices, mobile patient care facilities, diagnostic centers, lab centers, pharmacies, and the like. The providers may operate by providing health care services for patients and then invoicing one or more payors 160a and 160b for the services rendered. The payors 160a and 160b may include, but are not limited to, providers of private insurance plans, providers of government insurance plans (e.g., Medicare, Medicaid, state, or federal public employee insurance plans), providers of hybrid insurance plans (e.g., Affordable Care Act plans), providers of private medical cost sharing plans, and the patients themselves. One provider facility 110 is illustrated in FIG. 1 with the provider including a patient intake/accounting system server 105 accessible via a network 115. The patient intake/accounting system server 105 may be configured with a patient intake/accounting system module 120 to manage the intake of patients for appointments and to generate invoices for payors for services and products rendered through the provider 110. The network 115 communicatively couples the patient intake/accounting system server 105 to other devices, terminals, and systems in the provider's facility 110. The network 115 may comprise one or more local or wireless networks to communicate with patient intake/accounting system server 105 when the patient intake/accounting system server 105 is located in or proximate to the dental care service provider facility 110. When the patient intake/accounting system server 105 is in a remote location from the health care facility, such as part of a cloud computing system or at a central computing center, then the network 115 may include one or more wide area or global networks, such as the Internet.

According to some embodiments of the disclosure, an appeal generation assistant server 104 may include an appeal adjudication assistant module 135 that is configured to provide one or more AI models. The one or more AI models are trained to generate an appeal success prediction score based on an appeal support data set and a health care claim that has been denied by a payor 160a, 160b. The appeal support data set includes both clinical data associated with the patient and administrative data associated with the patient, such as demographic information and information associated with the patient's insurance policy, such as the policy type, which may include what benefits are provided through the policy, deductible information, co-payment information, and the like. The appeal generation assistant module may be further configured to provide an appeal data enrichment capability. In some instances, an appeal of a health care claim may be more likely to be approved by the payor if certain deficiencies are corrected in the original claim. For example, the claim may be missing, for example certain clinical information, one or more attachments, certain demographic information about the patient, e.g., age verification, marital status, and/or other information that the payor requires to approve payment for the claim. The appeal generation assistant 135 may be configured to apply a rule set associated with the payor along with responses, such as adjudication results or other feedback, from the payor to the appeal support data and health care claim to determine whether additional clinical or administrative information is needed to adjudicate the claim. Additional clinical or administrative information may be stored in one or more public and/or proprietary storage locations 130a, . . . , 130n.

A network 150 couples the patient intake/accounting system server 105 and payors 160a, 160b to the claim appeal generation assistant server 104. The network 150 may be a global network, such as the Internet or other publicly accessible network. Various elements of the network 150 may be interconnected by a wide area network, a local area network, an Intranet, and/or other private network, which may not be accessible by the general public. Thus, the communication network 150 may represent a combination of public and private networks or a virtual private network (VPN). The network 150 may be a wireless network, a wireline network, or may be a combination of both wireless and wireline networks.

The decision support system service for automatically generating appeal decisions provided through the appeal generation assistant server 104 may, in some embodiments, be embodied as a cloud service. For example, health care service providers 110 and/or other entities may access the decision support system service for automatically generating appeals as a Web service. In some embodiments, the decision support system service for automatically generating appeals may be implemented as a Representational State Transfer Web Service (RESTful Web service).

Although FIG. 1 illustrates an example communication network including an AI assisted decision support system for automatically generating appeals, it will be understood that embodiments of the inventive subject matter are not limited to such configurations, but are intended to encompass any configuration capable of carrying out the operations described herein.

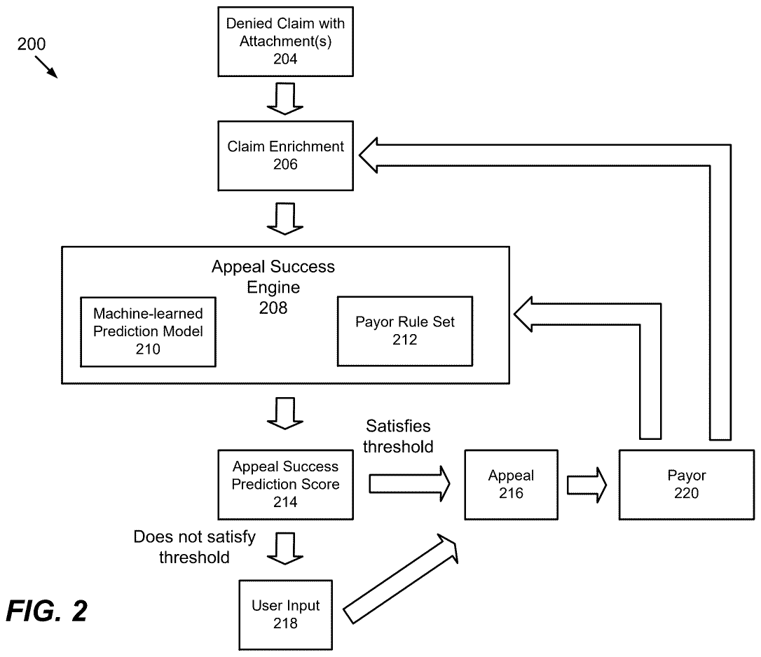

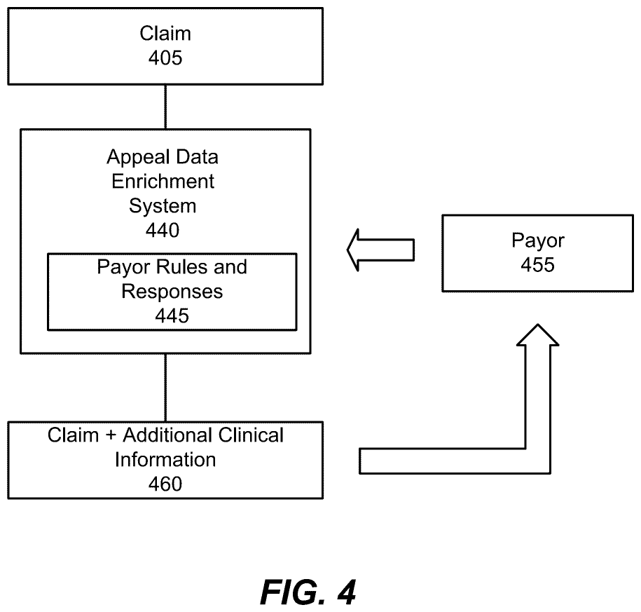

FIG. 2 is a block diagram that illustrates an AI assisted decision support system 200 for automatically generating health care claim appeals that may be embodied using the appeal generation assistant server 104 and appeal generation assistant module 135 of FIG. 1 in accordance with some embodiments of the disclosure. As shown in FIG. 2, a payor denies a health care claim by issuing a denial notification. The denied claim may be enriched at block 204 to increase the likelihood of success if the claim were to be appealed to the payor 220. FIG. 4 is a block diagram of an appeal data enrichment system 440 in accordance with some embodiments of the disclosure. Referring to FIG. 4, a claim 405 is provided to the appeal data enrichment system 440. The appeal data enrichment system 440 is configured with payor rules and responses from the payor, such as claim adjudication results, guidelines, commentary, reasoning for approving or denying claim(s), and the like 445 that are provided by a payor 455. These payor rules and responses 445 may specify the types of information, including quantitative information, such as thresholds, ranges, and the like, that may be contained in a claim that would result in the payor requiring additional clinical or administrative information for adjudicating the claim in a successful manner. The types of information or factors that may be used in making the determination of whether additional clinical or administrative information is needed to successfully adjudicate the claim may include the presence of one or more procedure codes (e.g., Current Procedural Terminology (CPT) codes) that are indicative of diagnoses, procedures, services, medications, or other forms of health care services or products. These procedure codes may be indicative of services and/or products that are of questionable medical necessity. Another type of information or factor that may be considered is whether the claim includes information of questionable accuracy. The appeal data enrichment system 440 may be configured to analyze the claim for internal consistency and may evaluate the particular provider that is submitting the claim based on the payor rules and responses 445. A payor may require providers that have a history of submitting claims with errant or incorrect information to provide supporting clinical information for the services and products listed on the claim more often than providers that have a history of submitting claims with lower error rates. The appeal data enrichment system 440 may be further configured to take into account the risk adjustment factor associated with the patient based on the payor rules and responses 445. A payor may require additional clinical information for a claim that lists services and/or products that are inconsistent with the expected healthcare use for the patient based on the patient's risk adjustment factor. Based on application of the payor rules and responses 445, a determination may be made whether additional clinical or administrative information is needed to adjudicate the claim and whether the claim includes this additional clinical or administrative information in the form of an attachment, addendum, or the like. The claim may be supplemented with additional clinical or administrative information 460, if needed, and may be communicated to the payor 455 as part of an appeal.

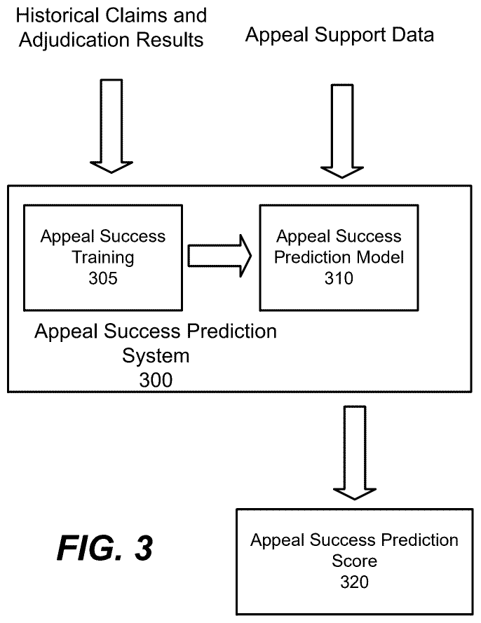

Returning to FIG. 2, the appeal support data set, which comprises clinical and administrative data associated with the patient along with the claim is provided to the appeal success engine with any enrichment applied through the addition of clinical and/or administrative information via the appeal data enrichment system of FIG. 4. The appeal success engine 208 includes a machine-learned prediction model 210. FIG. 3 is a block diagram that illustrates embodiments of an appeal success prediction system 300 in which a machine-learned model is trained to generate an appeal success prediction score for a health care claim that has been denied by a payor. As shown in FIG. 3, the appeal success prediction system 300 may be a machine-learned system comprising an appeal success training module 305 and an appeal success prediction model 310. The appeal success training module 305 is configured to receive historical health care claims associated with historical patients. Each of the historical health care claims includes historical clinical data and historical administrative data corresponding to a respective historical patient. The appeal success training module 305 is further configured to receive historical claim adjudication results from the payor 220. The historical clinical data may include one or more procedure with one or more health care procedures performed on the respective historical patient. The historical administrative data may include demographic information for the respective historical patient and information on a health care insurance policy associated with the respective historical patient. The training process generates learned associations between which claims are approved for payment and which claims are denied based on the historical claim and payor adjudication information received at the appeal success training module 305. Based on these learned associations the appeal success prediction model 310 is generated. When operating in inference mode, the appeal success prediction model 310 is applied to appeal support data, which includes a denied health care claim along with clinical and administrative data associated with the patient, to generate an appeal success prediction score 320. Similar to the training data, the clinical data may include one or more procedure codes respectively associated with one or more procedures performed on the patient and the administrative data may include demographic information for the patient and information on a health insurance policy associated with the patient. The appeal success prediction score 320 is used to determine whether to automatically generate an appeal of the denied claim. The appeal success training module 305 may perform the training and the appeal success prediction model 310 may operate in inference mode on a same set of one or more processors. In other embodiments, the appeal success training module 305 may perform the training operations using one or more processors included in a first computing entity and the appeal success prediction model 310 may operate in inference mode using one or more processors included in a second computing entity different from the first computing entity.

In some embodiments, the features used during training of the appeal success prediction model 310 may be evaluated to determine their relative impact on the appeal success prediction score 320. One or more features having a lesser impact on the success prediction score 320 than other features may be removed from the historical claim and adjudication results, e.g., historical clinical data, historical administrative data, historical demographic information, health care insurance policy information, and the like to reduce the overall dimensionality of the training data set used to train the appeal success prediction model. Similarly, these features may be removed from the appeal support data, which includes a denied health care claim along with clinical and administrative data associated with the patient, during inference mode to reduce the dimensionality of the features used by the appeal success prediction model 310 to generate the appeal success prediction score. By sparsifying the features used during training and/or during inference mode of the appeal success prediction model 310, the model may execute on one or more processors with decreased memory and computational requirements (e.g., processor speed and availability).

In some embodiments in which the appeal success prediction model 310 comprises a neural network, one or more nodes or paths of the neural network may be removed through setting certain parameters or weights to zero based on the sparsification of the features used during training and during inference mode. As a result, the sparsified neural network may run more efficiently and use fewer memory resources.

In some embodiments, one or more of the features used in training or during inference mode of the appeal success prediction model 310 may be selected to have different quantization levels, e.g., 64-bit, 32-bit, etc. to reduce the size and complexity of the appeal success prediction model 310.

Returning to FIG. 2, the appeal success prediction score 320 generated sing the appeal success prediction system 300 of FIG. 3 is output from the appeal success engine 208 as the appeal success prediction score 214. If the appeal success prediction score satisfies an appeal success threshold, then an appeal of the denied claim is automatically generated as appeal 216. If the appeal success prediction score 214 does not satisfy the appeal success threshold, then a user may still choose to proceed with the automatic generation of an appeal by providing user input at block 218. When the user authorizes the appeal, the appeal is automatically generated as appeal 216. The appeal success threshold may be a configurable parameter that can be adjusted based on statistics on how successful the automatically generated appeals are in obtaining payor approval. The appeal 216 may be generated in a format compatible with a standard defined by the payor 220 to ensure that the appeal can be readily processed by the payor's appeal processing system. Moreover, the appeal 216 may be communicated to the payor using a communication protocol that is compatible with the system that payor uses in processing the appeal.

In addition to the machine-learned prediction model 210, the appeal success engine 208 may further include a rules engine that is based on payor rule set 212. As described above with respect to FIG. 4, the payor rule set 212 may include one or more administrative rules used by the payor 220 in health care claim adjudication. These rules may, in some embodiments, comprise a core set of rules, such as CMS rules, which are applicable to multiple payors including the payor 220, and may be supplemented with specific rules that are unique to the payor 220. The payor rule set 212 may be applied to the appeal support data and the health care claim to generate a second appeal success prediction score. The appeal success prediction score output through application of the payor rule set module and the appeal success prediction score output through the machine-learned prediction model may be logically and/or mathematically combined to generate a composite appeal success prediction score that is output at block 214. Similar to the description above, a determination is made whether the composite appeal success prediction score satisfies a composite appeal success threshold. If so, the claim may be automatically appealed and if not, the claim may still be automatically appealed in response to user input as described above. The addition of the payor rule set 212 to provide a second appeal success prediction score may improve the overall appeal success rate by basing the decision of whether to automatically appeal a denied claim on the outputs of two at least partially independent prediction systems.

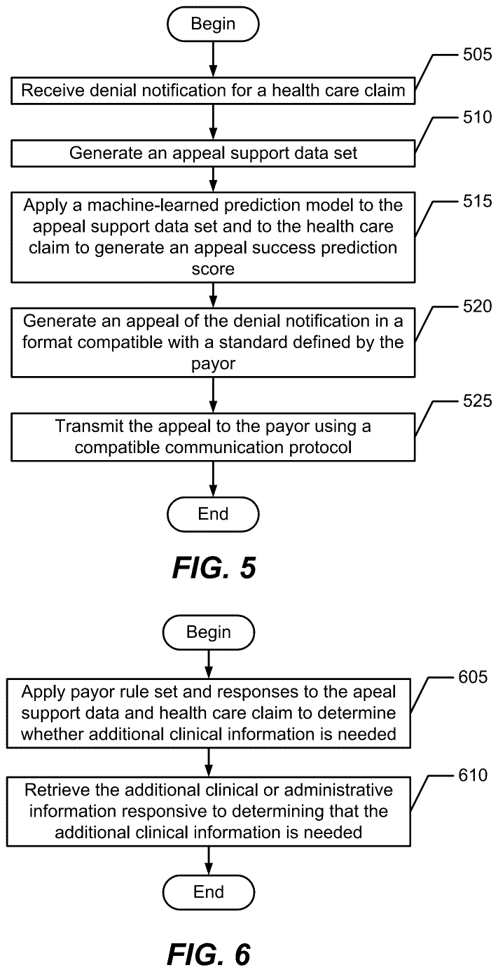

FIGS. 5 and 6 are flowcharts that illustrate operations of the AI assisted decision support system for automatically generating health care claim appeals in accordance with some embodiments of the disclosure. Operations begin at block 505 where a denial notification for a health care claim associated with a patient is received. An appeal support data set is generated at block 510, which includes clinical data associated with the patient along with administrative data associated with the patient. The clinical data may include, for example, one or more procedure codes (e.g., Current Procedural Terminology (CPT) codes) from the patient's clinical record. The administrative data may include demographic information for the patient and/or information on a health care insurance policy associated with the patient. This may include the identification of a particular coverage plan and the characteristics associated therewith, such as deductibles, co-payments, and the like. A machine-learned prediction model is applied to the appeal support data and to the health care claim to generate an appeal success prediction score at block 515. The appeal success prediction score is indicative of a likelihood that the denied claim will be approved if re-submitted in its current or a modified form. An appeal is automatically generated at block 520 in a format compatible with a standard defined by the payor when the appeal success prediction score satisfies an appeal success threshold. The appeal is transmitted to the payor at block 525 using a communication protocol that is compatible with a system used by the payor in processing the appeal.

In some embodiments, a generative AI system may be used to automatically generate the appeal based on format requirements that may be provided, for example, by a payor, such as via a PI document, along with information and/or data from the denied claim and patient's medical record. In some embodiments, a Natural Language Processing (NLP) system, such as a language model, may be used to process the payor's format requirements (e.g., PI document), the denied claim, the denial notification, clinical data associated with the patient, and/or administrative data associated with the patient to interpret and extract the information contained therein to generate appeal content, which can be used by the generative AI system to generate the appeal.

A language model is a type of machine-learned model that is trained to conduct a probability distribution over words. Language models may include, for example, statistical models and those based on deep neural networks, e.g., neural language models. Statistical language models are a type of model that use statistical patterns in the data to make predictions about the likelihood of specific sequences of words. One approach to building a probabilistic language model is to calculate n-gram probabilities. An n-gram is a sequence of words, where n is a number greater than zero. To make a simple probabilistic language model, the likelihood of different n-grams, i.e., word combinations, in a portion of text is calculated. This may be done by counting the number of times each word combination appears and dividing it by the number of times the previous word appears. This approach is based on a concept called Markov assumption, which says that the probability of the next word in a sequence depends only on a fixed size window of previous words.

Neural language models predict the likelihood of a sequence of words using a neural network model. Neural language models may capture context better than traditional statistical models. Neural language models may also handle more complex language structure and longer dependencies between words. The neural network model may be trained using a large training set of text data and are generally capable of learning the underlying structure of the language. Recurrent Neural Networks (RNNs) are a type of neural network that can memorize the previous outputs when receiving the next inputs. This is in contrast to traditional neural networks, where inputs and outputs are independent of each other. RNNs may be particularly useful when it is necessary to predict the next word in a sentence, as they can take into account the previous words in the sentence. RNNs, however, can be computationally expensive and may not scale well to very long input sequences.

A Large Language Model (LLM) is a language model that is characterized by its large size, which is enabled by AI hardware accelerators allowing the model to process vast amounts of data. A large language model may be based on a neural network, which can contain a large number of weights and may be pre-trained using self-supervised and/or semi-supervised learning. In some embodiments, a large language model may be based on a transformer architecture. The transformer name is based on the ability of the architecture to transform one sequence into another. Moreover, the transformer architecture provides for the ability to process an entire word sequence at once as opposed to one step at a time, such as is done in RNNs. This parallelization allows large language models based on a transformer architecture to be faster to train and operate in inference mode thereby improving the performance of a computer system.

As described above, a health care claim that has been denied may be enriched or supplemented with additional or revised information that would increase the likelihood that the claim would be approved when an appeal is submitted to the payor. For example, referring to FIG. 6, operations begin at block where the payor rule set and payor responses including the administrative rules described above are applied to the appeal support data and the health care claim to determine whether additional clinical or administrative information may be needed by the payor to approve the claim for payment.

When a determination is made that additional clinical or administrative information is needed, the additional clinical or administrative information needed to supplement the claim may be automatically retrieved from storage locations, such as storage end points 130a, . . . , 130n, without the need for manual intervention at block 610. These retrieval techniques may include, but are not limited to, accessing a storage area to retrieve the additional clinical or administrative information using Fast Healthcare Interoperability Resources (FHIR) protocol, sending a request to the provider to return the additional clinical or administrative information in an Electronic Data Interchange (EDI) format, or sending an electronic mail message to the provider requesting the additional clinical or administrative information. The storage area may be implemented in a variety of different ways in accordance with various embodiments of the disclosure. For example, the storage area may be part of one or more clinical networks that may be used to implement a local area, wide area, or national health information exchange, e.g., a publicly accessible networked health information exchange. In other embodiments, a provider may implement its own proprietary network endpoint for housing its own clinical data. The provider may grant other entities direct access to its own electronic health records stored at this end point.

As described above with respect to FIGS. 2 and 4, once additional clinical or administrative information is retrieved by, for example, retrieving a patient's medical record, the additional clinical or administrative information may be communicated along with the claim to the payor as part of the appeal. A patient's medical record may be large and include much information that is not needed by the payor to adjudicate the claim. In some embodiments, a claim may be enriched or supplemented by extracting a portion of the patient's medical record that is relevant to adjudication of the claim.

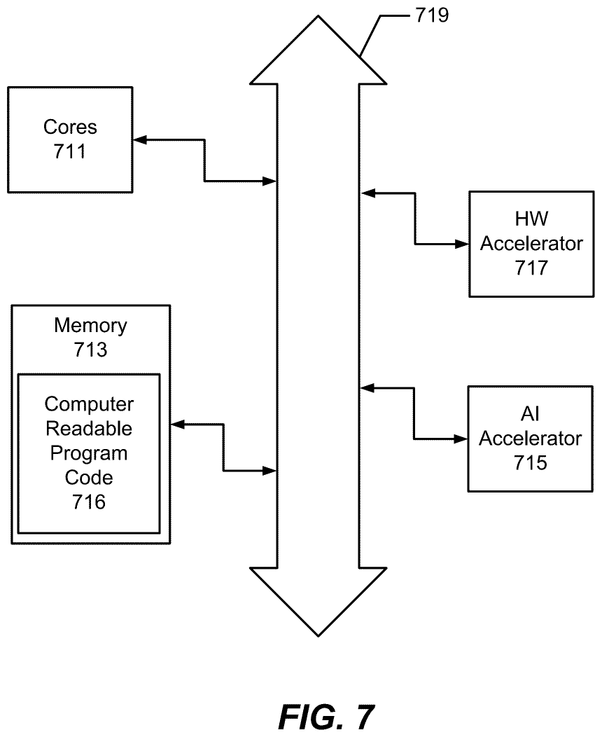

FIG. 7 is a block diagram of a data processing system that may be used to implement the appeal generation assistant server 104 of FIG. 1, the AI based appeal success prediction system 300 of FIG. 3, and the appeal data enrichment system 440 of FIG. 4. As shown in FIG. 7, the data processing system may include at least one core 711, a memory 713, an artificial intelligence (AI) accelerator 715, and a hardware (HW) accelerator 717. The at least one core 711, the memory 713, the AI accelerator 715, and the HW accelerator 717 may communicate with each other through a bus 719.

The at least one core 711 may be configured to execute computer program instructions. For example, the at least one core 711 may execute an operating system and/or applications represented by the computer readable program code 716 stored in the memory 713. In some embodiments, the at least one core 711 may be configured to instruct the AI accelerator 715 and/or the HW accelerator 717 to perform operations by executing the instructions and obtain results of the operations from the AI accelerator 715 and/or the HW accelerator 717. In some embodiments, the at least one core 711 may be an Application Specific Instruction Set Processor (ASIP) customized for specific purposes and support a dedicated instruction set.

The memory 713 may have an arbitrary structure configured to store data. For example, the memory 713 may include a volatile memory device, such as dynamic random-access memory (DRAM) and static RAM (SRAM), or include a non-volatile memory device, such as flash memory and resistive RAM (RRAM). The at least one core 711, the AI accelerator 715, and the HW accelerator 717 may store data in the memory 713 or read data from the memory 713 through the bus 719.

The AI accelerator 715 may refer to hardware designed for AI applications. In some embodiments, the AI accelerator 715 may include a machine learning model and/or other AI models configured to facilitate operations associated with an AI assisted decision support system for automatically generating appeals of a decision as described above with respect to FIGS. 2-6. The AI accelerator 715 may generate output data by processing input data provided from the at least one core 715 and/or the HW accelerator 717 and provide the output data to the at least one core 711 and/or the HW accelerator 717. In some embodiments, the AI accelerator 715 may be programmable and be programmed by the at least one core 711 and/or the HW accelerator 717. The HW accelerator 717 may include hardware designed to perform specific operations at high speed. The HW accelerator 717 may be programmable and be programmed by the at least one core 711.

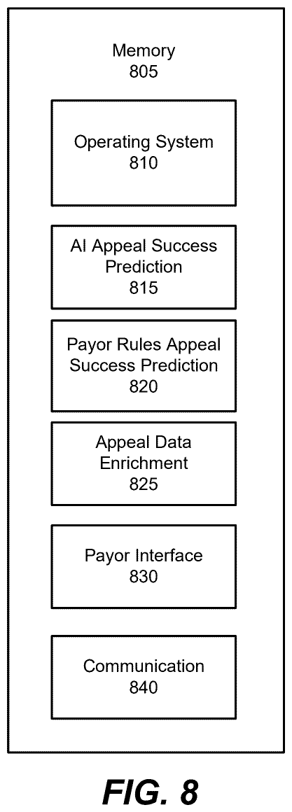

FIG. 8 illustrates a memory 805 that may be used in embodiments of data processing systems, such as the appeal generation assistant server 104 of FIG. 1, the AI based appeal success prediction system 300 of FIG. 3, the appeal data enrichment system 440 of FIG. 4, and the data processing system of FIG. 7, respectively, to facilitate the automatic generation of appeals of a decision using one or more AI models. The memory 805 is representative of the one or more memory devices containing the software and data used for facilitating operations of the appeal generation assistant server 104 of FIG. 1, the AI based appeal success prediction system 300 of FIG. 3, and the appeal data enrichment system 440 of FIG. 4 as described herein. The memory 805 may include, but is not limited to, the following types of devices: cache, ROM, PROM, EPROM, EEPROM, flash, SRAM, and DRAM. As shown in FIG. 8, the memory 805 may contain six or more categories of software and/or data: an operating system 810, an AI appeal success prediction module 815, a payor rules appeal success prediction module 820, an appeal data enrichment module 825, a payor interface 830, and a communication module 840.

In particular, the operating system 810 may manage the data processing system's software and/or hardware resources and may coordinate execution of programs by the processor. The AI appeal success prediction module 815 may be configured to perform one or more of the operations described above with respect to the machine-learned prediction model 210 of FIG. 2, the AI based appeal success prediction system 300 of FIG. 3, and the flowcharts of FIGS. 5 and 6. The payor rules appeal success prediction module 820 may be configured to perform one or more of the operations described above with respect to the payor rule set 212 of FIG. 2 and the flowcharts of FIGS. 5 and 6. The appeal data enrichment module 825 may be configured to perform one or more of the operations described above with respect to the claim enrichment block 206 of FIG. 2, the appeal data enrichment system 440 of FIG. 4, and the flowcharts of FIGS. 5 and 6. The payor interface 830 may be configured to conform the appeal to a standard defined by the payor to ensure that the appeal can be processed by the payor's system. The communication module 840 may be configured to facilitate communication between the appeal generation assistant server 104 and the payor using communication protocols that are compatible with one or more systems used by the payor in processing the appeal. The communication module 840 may also facilitate communication between the appeal generation assistant server 104 and one or more storage location containing additional clinical and/or administrative information for enriching or supplementing appeal data.

Although FIG. 8 illustrates hardware/software architectures that may be used in data processing systems, such as the appeal generation assistant server 104 of FIG. 1 and the data processing system of FIG. 7, respectively, in accordance with some embodiments of the disclosure, it will be understood that embodiments of the present disclosure are not limited to such a configuration but is intended to encompass any configuration capable of carrying out operations described herein.

Computer program code for carrying out operations of data processing systems discussed above with respect to FIGS. 1-8 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the appeal generation assistant server 104 and the data processing system of FIG. 7 may each be implemented as a single processor system, a multi-processor system, a multi-core processor system, or even a network of stand-alone computer systems, in accordance with various embodiments of the disclosure. Each of these processor/computer systems may be referred to as a “processor” or “data processing system.” The functionality provided by the appeal generation assistant server 104 may be embodied as a single server or embodied as separate servers in accordance with different embodiments of the disclosure.

The data processing apparatus described herein with respect to FIGS. 1-8 may be used to facilitate the automatic generation of appeals of decisions, such as a denial of a health care claim by a payor, using one or more AI models according to some embodiments of the disclosure described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 713 and memory 805 when coupled to a processor includes computer readable program code that, when executed by the processor, causes the processor to perform operations including one or more of the operations described herein with respect to FIGS. 1-6.

Some of the embodiments of the disclosure may provide an AI assisted decision support system that may be used generally to automatically generate an appeal of a decision by an adjudicative authority. In particular embodiments, the appeal may be of a health care claim that has been denied in whole or in part by a payor. The AI assisted decision support system may be configured to automatically determine which claims that have been denied by a payor may have a satisfactorily high probability of being approved by the payor if they are appealed. A trained machine-learned prediction model may be used alone or in conjunction with a rules engine associated with a payor to generate an appeal success prediction score. When the appeal success prediction score satisfies an appeal success threshold, an appeal of a denied claim may be automatically generated in a format compatible with a standard defined by the payor that denied the claim. Moreover, the appeal may be automatically communicated to the payor using a communication protocol that is compatible with a system used by the payor in processing the appeal.

In addition to automatically generating the appeal, the claim may be enriched or supplemented with additional clinical or administrative information to increase the likelihood that the claim will be approved by the payor on appeal. Various clinical information retrieval techniques can be used to retrieve the additional information from public and/or proprietary networked locations.

Some embodiments of the disclosure may provide an AI assisted decision support system as set forth by the following examples:

Example 1: a computer-implemented method comprises: receiving, by one or more processors, a denial notification for a health care claim associated with a patient; generating, by the one or more processors, an appeal support data set, the appeal support data set comprising clinical data associated with the patient and administrative data associated with the patient, the appeal support data set being a sparsified subset of a larger appeal support data set and having a reduced dimensionality relative to the larger appeal support data set; applying, by the one or more processors and to the appeal support data set and the health care claim, a machine-learned prediction model that is trained to generate an appeal success prediction score; generating, by the one or more processors, an appeal of the denial notification in a format compatible with a standard defined by a payor that issued the denial notification when the appeal success prediction score satisfies an appeal success threshold; and transmitting, by the one or more processors, the appeal to the payor that issued the denial notification using a communication protocol compatible with a system used by the payor in processing the appeal.

Example 2: the computer-implemented method according to Example 1, wherein the computer-implemented method further comprises: training the machine-learned prediction model using historical health care claims associated with historical patients, each of the historical health care claims including historical clinical data and historical administrative data corresponding to a respective historical patient, and using historical claim adjudication results from the payor; wherein the historical clinical data includes one or more procedure codes respectively associated with one or more health care procedures performed on the respective historical patient; and wherein the historical administrative data includes demographic information for the respective historical patient and information on a health care insurance policy associated with the respective historical patient.

Example 3: the computer-implemented method according to any of Examples 1-2, wherein generating the appeal of the denial notification comprises: applying a language model to the denial notification, the appeal support data set, the health care claim, and a process instruction document to extract appeal content therefrom; and using a generative Artificial Intelligence system to generate the appeal based on the appeal content.

Example 4: the computer-implemented method according to any of Examples 1-3, wherein the appeal success prediction score is a first appeal success prediction score, the computer-implemented method further comprising: applying, by the one or more processors and to the appeal support data and the health care claim, a payor rule set to generate a second appeal success prediction score, the payor rule set including one or more administrative rules used by the payor in health care claim adjudication.

Example 5: the computer-implemented method according to Example 4, wherein the computer-implemented method further comprises: combining the first appeal success prediction score and the second appeal success prediction score to generate a composite appeal success prediction score; wherein generating the appeal of the denial notification comprises: generating, by the one or more processors, the appeal of the denial notification in the format compatible with the standard defined by the payor that issued the denial notification when the composite appeal success prediction score satisfies a composite appeal success threshold.

Example 6: the computer-implemented method according to any of Examples 4-5, wherein the payor rule set comprises a common rule set that is applicable to multiple payors and a specific rule set that is unique to the payor.

Example 7: the computer-implemented method according to any of Examples 4-6, wherein the computer-implemented method further comprises: applying, by the one or more processors and to the appeal support data and the health care claim, the payor rule set and payor responses to determine whether additional clinical or administrative information is needed to adjudicate the claim; retrieving, by the one or more processors, the additional clinical or administrative information responsive to determining that the additional clinical or administrative information is needed to adjudicate the claim; and supplementing the health care claim with the additional clinical or administrative information; wherein the appeal includes the health care claim supplemented with the additional clinical or administrative information

Example 8: the computer-implemented method according to any of Examples 4-7, wherein the additional clinical or administrative information is electronically stored in a networked public health information exchange storage area or a networked proprietary health information storage area, which are accessible by one or more entities in addition to a provider of health care services to the patient.

Example 9: the computer-implemented method according to any of Examples 7-8, wherein retrieving the additional clinical or administrative information comprises: applying, by the one or more processors, one or more of a plurality of retrieval techniques to electronically retrieve the additional clinical or administrative information.

Example 10: the computer-implemented method according to Example 9, wherein the plurality of retrieval techniques comprises an automated data pull technique. a request-response technique, a Fast Healthcare Interoperability Resources (FHIR) protocol, sending a request to the provider to return the additional clinical or administrative information in an Electronic Data Interchange (EDI) format, and sending an electronic mail message to the provider requesting the additional clinical or administrative information.

Example 11: the computer-implemented method according to any of Examples 1-10, wherein the computer-implemented method further comprises: receiving, by the one or more processors, user input authorizing an appeal when the appeal success prediction score does not satisfy the appeal success threshold; wherein generating the appeal of the denial notification comprises: generating, by the one or more processors, the appeal of the denial notification in the format compatible with the standard defined by the payor that issued the denial notification responsive to the user input authorizing the appeal.

Example 12: the computer-implemented method according to any of Examples 1-11, wherein the clinical data includes one or more procedure codes respectively associated with one or more health care procedures performed on the patient; and the administrative data includes demographic information for the patient and information on a health care insurance policy associated with the patient.

Example 13: a system comprises one or more processors; and one or more memories storing process-executable instructions that, when executed by the one or more processors, cause the one or more processors to perform operations comprising: receiving a denial notification for a health care claim associated with a patient; generating an appeal support data set, the appeal support data set comprising clinical data associated with the patient and administrative data associated with the patient, the appeal support data set being a sparsified subset of a larger appeal support data set and having a reduced dimensionality relative to the larger appeal support data set; applying to the appeal support data set and the health care claim a machine-learned prediction model that is trained to generate an appeal success prediction score; generating an appeal of the denial notification in a format compatible with a standard defined by a payor that issued the denial notification when the appeal success prediction score satisfies an appeal success threshold; and transmitting the appeal to the payor that issued the denial notification using a communication protocol compatible with a system used by the payor in processing the appeal.

Example 14: the system according to Example 13, wherein the appeal success prediction score is a first appeal success prediction score, the operations further comprising: applying to the appeal support data and the health care claim a payor rule set to generate a second appeal success prediction score, the payor rule set including one or more administrative rules used by the payor in health care claim adjudication.

Example 15: the system according to any of Examples 13-14, wherein the operations further comprise: combining the first appeal success prediction score and the second appeal success prediction score to generate a composite appeal success prediction score; wherein generating the appeal of the denial notification comprises: generating the appeal of the denial notification in the format compatible with the standard defined by the payor that issued the denial notification when the composite appeal success prediction score satisfies a composite appeal success threshold.

Example 16: the system according to any of Examples 14-15, wherein the operations further comprise: applying to the appeal support data and the health care claim the payor rule set and payor responses to determine whether additional clinical or administrative information is needed to adjudicate the claim; retrieving the additional clinical or administrative information responsive to determining that the additional clinical or administrative information is needed to adjudicate the claim; and supplementing the health care claim with the additional clinical or administrative information; wherein the appeal includes the health care claim supplemented with the additional clinical or administrative information.

Example 17: the system according to Example 16, wherein the additional clinical or administrative information is electronically stored in a networked public health information exchange storage area or a networked proprietary health information storage area, which are accessible by one or more entities in addition to a provider of health care services to the patient.

Example 18: the system according to any of Examples 16-17, wherein retrieving the additional clinical or administrative information comprises: applying one or more of a plurality of retrieval techniques to electronically retrieve the additional clinical or administrative information.

Example 19: the system according to any of Examples 13-18, wherein the operations further comprise: receiving user input authorizing an appeal when the appeal success prediction score does not satisfy the appeal success threshold; wherein generating the appeal of the denial notification comprises: generating the appeal of the denial notification in the format compatible with the standard defined by the payor that issued the denial notification responsive to the user input authorizing the appeal.

Example 20: one or more non-transitory computer-readable media storing processor-executable instructions that, when executed by one or more processors, cause the one or more processors to perform operations comprising: receiving a denial notification for a health care claim associated with a patient; generating an appeal support data set, the appeal support data set comprising clinical data associated with the patient and administrative data associated with the patient, the appeal support data set being a sparsified subset of a larger appeal support data set and having a reduced dimensionality relative to the larger appeal support data set; applying to the appeal support data set and the health care claim a machine-learned prediction model that is trained to generate an appeal success prediction score; generating an appeal of the denial notification in a format compatible with a standard defined by a payor that issued the denial notification when the appeal success prediction score satisfies an appeal success threshold; and transmitting the appeal to the payor that issued the denial notification using a communication protocol compatible with a system used by the payor in processing the appeal.

Example 21: the computer-implemented method according to Example 2, wherein training the machine-learned prediction model is performed by one or more processors.

Example 22: the computer-implemented method according to Example 2, wherein the one or more processors are included in a first computing entity; and wherein training the machine-learned prediction model is performed by one or more processors included in a second computing entity.

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

The embodiments of the present disclosure have been presented for purposes of illustration and description, but are not intended to be exhaustive or limited to the disclosure in the form disclosed. Many modifications and variations may be apparent to those of ordinary skill in the art without departing from the scope and spirit of the disclosure. The aspects of the disclosure herein were chosen and described to best explain the principles of the disclosure and the practical application thereof, and to enable others of ordinary skill in the art to understand the disclosure with various modifications as are suited to the particular use contemplated.

What is claimed is:

1. A computer-implemented method, comprising:
receiving, by one or more processors, a denial notification for a health care claim associated with a patient;
generating, by the one or more processors, an appeal support data set, the appeal support data set comprising clinical data associated with the patient and administrative data associated with the patient, the appeal support data set being a sparsified subset of a larger appeal support data set and having a reduced dimensionality relative to the larger appeal support data set;
applying, by the one or more processors and to the appeal support data set and the health care claim, a machine-learned prediction model that is trained to generate an appeal success prediction score;
generating, by the one or more processors, an appeal of the denial notification in a format compatible with a standard defined by a payor that issued the denial notification when the appeal success prediction score satisfies an appeal success threshold; and
transmitting, by the one or more processors, the appeal to the payor that issued the denial notification using a communication protocol compatible with a system used by the payor in processing the appeal.

2. The computer-implemented method of claim 1, further comprising:
training the machine-learned prediction model using historical health care claims associated with historical patients, each of the historical health care claims including historical clinical data and historical administrative data corresponding to a respective historical patient, and using historical claim adjudication results from the payor;
wherein the historical clinical data includes one or more procedure codes respectively associated with one or more health care procedures performed on the respective historical patient; and
wherein the historical administrative data includes demographic information for the respective historical patient and information on a health care insurance policy associated with the respective historical patient.

3. The computer-implemented method of claim 1, wherein generating the appeal of the denial notification comprises:
applying a language model to the denial notification, the appeal support data set, the health care claim, and a process instruction document to extract appeal content therefrom; and
using a generative Artificial Intelligence system to generate the appeal based on the appeal content.

4. The computer-implemented method of claim 1, wherein the appeal success prediction score is a first appeal success prediction score, the computer-implemented method further comprising:
applying, by the one or more processors and to the appeal support data and the health care claim, a payor rule set to generate a second appeal success prediction score, the payor rule set including one or more administrative rules used by the payor in health care claim adjudication.

5. The computer-implemented method of claim 4, further comprising:
combining the first appeal success prediction score and the second appeal success prediction score to generate a composite appeal success prediction score;
wherein generating the appeal of the denial notification comprises:
generating, by the one or more processors, the appeal of the denial notification in the format compatible with the standard defined by the payor that issued the denial notification when the composite appeal success prediction score satisfies a composite appeal success threshold.

6. The computer-implemented method of claim 4, wherein the payor rule set comprises a common rule set that is applicable to multiple payors and a specific rule set that is unique to the payor.

7. The computer-implemented method of claim 4, further comprising:
applying, by the one or more processors and to the appeal support data and the health care claim, the payor rule set and payor responses to determine whether additional clinical or administrative information is needed to adjudicate the claim;
retrieving, by the one or more processors, the additional clinical or administrative information responsive to determining that the additional clinical or administrative information is needed to adjudicate the claim; and
supplementing the health care claim with the additional clinical or administrative information;
wherein the appeal includes the health care claim supplemented with the additional clinical or administrative information.

8. The computer-implemented method of claim 7, wherein the additional clinical or administrative information is electronically stored in a networked public health information exchange storage area or a networked proprietary health information storage area, which are accessible by one or more entities in addition to a provider of health care services to the patient.

9. The computer-implemented method of claim 7, wherein retrieving the additional clinical or administrative information comprises:
applying, by the one or more processors, one or more of a plurality of retrieval techniques to electronically retrieve the additional clinical or administrative information.

10. The computer-implemented method of claim 9, wherein the plurality of retrieval techniques comprises an automated data pull technique. a request-response technique, a Fast Healthcare Interoperability Resources (FHIR) protocol, sending a request to the provider to return the additional clinical or administrative information in an Electronic Data Interchange (EDI) format, and sending an electronic mail message to the provider requesting the additional clinical or administrative information.

11. The computer-implemented method of claim 1, further comprising:
receiving, by the one or more processors, user input authorizing an appeal when the appeal success prediction score does not satisfy the appeal success threshold;
wherein generating the appeal of the denial notification comprises:
generating, by the one or more processors, the appeal of the denial notification in the format compatible with the standard defined by the payor that issued the denial notification responsive to the user input authorizing the appeal.

12. The computer-implemented method of claim 1, wherein the clinical data includes one or more procedure codes respectively associated with one or more health care procedures performed on the patient; and
wherein the administrative data includes demographic information for the patient and information on a health care insurance policy associated with the patient.

13. A system, comprising:
one or more processors; and
one or more memories storing process-executable instructions that, when executed by the one or more processors, cause the one or more processors to perform operations comprising:
receiving a denial notification for a health care claim associated with a patient;
generating an appeal support data set, the appeal support data set comprising clinical data associated with the patient and administrative data associated with the patient, the appeal support data set being a sparsified subset of a larger appeal support data set and having a reduced dimensionality relative to the larger appeal support data set;
applying to the appeal support data set and the health care claim a machine-learned prediction model that is trained to generate an appeal success prediction score;
generating an appeal of the denial notification in a format compatible with a standard defined by a payor that issued the denial notification when the appeal success prediction score satisfies an appeal success threshold; and
transmitting the appeal to the payor that issued the denial notification using a communication protocol compatible with a system used by the payor in processing the appeal.

14. The system of claim 13, wherein the appeal success prediction score is a first appeal success prediction score, the operations further comprising:
applying to the appeal support data and the health care claim a payor rule set to generate a second appeal success prediction score, the payor rule set including one or more administrative rules used by the payor in health care claim adjudication.

15. The system of claim 14, wherein the operations further comprise:
combining the first appeal success prediction score and the second appeal success prediction score to generate a composite appeal success prediction score;
wherein generating the appeal of the denial notification comprises:
generating the appeal of the denial notification in the format compatible with the standard defined by the payor that issued the denial notification when the composite appeal success prediction score satisfies a composite appeal success threshold.

16. The system of claim 14, wherein the operations further comprise:
applying to the appeal support data and the health care claim the payor rule set and payor responses to determine whether additional clinical or administrative information is needed to adjudicate the claim;
retrieving the additional clinical or administrative information responsive to determining that the additional clinical or administrative information is needed to adjudicate the claim; and
supplementing the health care claim with the additional clinical or administrative information;
wherein the appeal includes the health care claim supplemented with the additional clinical or administrative information.

17. The system of claim 16, wherein the additional clinical or administrative information is electronically stored in a networked public health information exchange storage area or a networked proprietary health information storage area, which are accessible by one or more entities in addition to a provider of health care services to the patient.

18. The system of claim 16, wherein retrieving the additional clinical or administrative information comprises:
applying one or more of a plurality of retrieval techniques to electronically retrieve the additional clinical or administrative information.

19. The system of claim 13, wherein the operations further comprise:
receiving user input authorizing an appeal when the appeal success prediction score does not satisfy the appeal success threshold;
wherein generating the appeal of the denial notification comprises:
generating the appeal of the denial notification in the format compatible with the standard defined by the payor that issued the denial notification responsive to the user input authorizing the appeal.

20. One or more non-transitory computer-readable media storing processor-executable instructions that, when executed by one or more processors, cause the one or more processors to perform operations comprising:
receiving a denial notification for a health care claim associated with a patient;
generating an appeal support data set, the appeal support data set comprising clinical data associated with the patient and administrative data associated with the patient, the appeal support data set being a sparsified subset of a larger appeal support data set and having a reduced dimensionality relative to the larger appeal support data set;
applying to the appeal support data set and the health care claim, a machine-learned prediction model that is trained to generate an appeal success prediction score;
generating an appeal of the denial notification in a format compatible with a standard defined by a payor that issued the denial notification when the appeal success prediction score satisfies an appeal success threshold; and
transmitting the appeal to the payor that issued the denial notification using a communication protocol compatible with a system used by the payor in processing the appeal.
